(19) United States
(12) Patent Application Publication
(10) Pub. No.: US 2011/0076460 A1
(43) Pub. Date: Mar. 31, 2011

(54) PLASTIC WITH NANO-EMBOSSING PATTERN AND METHOD FOR PREPARING THE SAME

(75) Inventors: Kwang Ryeol Lee, Seoul (KR); Myoung Woon Moon, Seoul (KR); Faruque Ahmed Sk, Seoul (KR); Yong Jun Jang, Seongnam (KR); Ki Chun Lee, Seoul (KR)

(73) Assignees: HYUNDAI MOTOR COMPANY, Seoul (KR); KIA MOTORS CORPORATION, Seoul (KR); KOREA INSTITUTE OF SCIENCE AND TECHNOLOGY, Seoul (KR)

(21) Appl. No.: 12/752,244

(22) Filed: Apr. 1, 2010

(30) Foreign Application Priority Data
Sep. 28, 2009 (KR) 10-2009-0091474

(51) Int. Cl. B32B 1/00; B29C 35/08

(52) U.S. Cl. 428/174; 264/405

(57) ABSTRACT

The present invention features a plastic with a nano-embossing pattern formed on the surface of polypropylene (PP) by preferably irradiating an argon ion beam, and a method for preparing the same. In preferred embodiments, the present invention also provides a method for preparing a plastic with a nano-embossing pattern formed on the surface thereof.

### CROSS-REFERENCE TO RELATED APPLICATION

This application claims under 35 U.S.C. §119(a) the benefit of Korean Patent Application No. 10-2009-0091474 filed Sep. 28, 2009, the entire contents of which are incorporated herein by reference.

### BACKGROUND

(a) Technical Field

The present disclosure relates, generally, to a plastic with a nano-embossing pattern formed on the surface thereof and a method for preparing the same. In particular embodiments, it relates to a plastic with a nano-embossing pattern formed on the surface of polypropylene (PP) by irradiating an argon ion beam, and a method for preparing the same.

(b) Background Art

Many types of plastic products with attractive appearances are widely used as interior and exterior materials for vehicles, home electronic appliances, electronic devices, etc. Further, materials with a variety of shapes and forms are provided for newer and special designs.

For example, although an interior material which has undergone an artificial embossing process to create a three-dimensional effect has been developed, it is considerably difficult to finely adjust the depth or size of an embossing pattern by the existing complicated hot-embossing methods, and thus the degree of freedom in controlling the shape and size of an embossing pattern is limited, in spite of its three-dimensional and aesthetic effects.

Further, plastic materials such as polypropylene (PP) are widely used as interior and exterior materials for vehicles and electronic devices due to certain advantages such as excellent moldability, lightweight, and relatively low price; however, plastic materials are vulnerable to scratching.

Accordingly, various types of surface treatment techniques such as painting and plating are used to treat the surface of plastic; however, the cost incurred in the painting or plating process is suitably increased.

Therefore, there is a need in the art for a plastic product with improved features or functionality, such as the prevention of stain due to static electricity, scratch resistance, and anti-sliding performance, and further there is a need in the art to produce a plastic product of high quality with an improvement in color by a surface treatment.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In certain preferred aspects, the present invention provides a plastic with a micro/nano-scale embossing pattern as a polymer nanostructure formed on the surface of polypropylene (PP) by suitably irradiating an argon ion beam, and a method for preparing the same. Preferably, the plastic with the nano-embossing pattern in accordance with the present invention can suitably satisfy preferred design requirements that finely adjust the size of the embossing pattern and the preferred functional requirements that suitably improve the prevention of stain due to static electricity, the scratch resistance, and the anti-sliding performance and produce a product of high quality with an improvement in color, thus being usefully applied in various fields such as interior and exterior materials for vehicles, home electronic appliances, electronic devices, etc.

In a preferred embodiment, the present invention provides a method for preparing a plastic with a nano-embossing pattern formed on the surface thereof, the method preferably characterized in that a surface treatment is suitably performed on the surface of a polymer material in a vacuum chamber by irradiating an ion beam onto the surface of the polymer material while suitably controlling the irradiation time and the magnitude of the acceleration voltage, thus forming a nano-embossing pattern on the surface of the polymer material.

In a preferred embodiment, the ion beam is produced by plasma ionization of a gas selected from the group consisting of, but not necessarily limited to, argon, oxygen, nitrogen, helium, and carbon tetrafluoride (CF₄).

In another preferred embodiment, the pressure of the chamber is in a range of 1.0×10⁻⁷ to 2.75×10⁻³ Pa.

In still another preferred embodiment, the shape of the nano-embossing pattern is suitably controlled by controlling at least one of the irradiation time of the ion beam and the magnitude of the acceleration voltage.

In yet another preferred embodiment, the irradiation time of the ion beam is preferably in a range of a few seconds to a few hours and the magnitude of the acceleration voltage is in a range of 100 V to 100 kV.

In still yet another preferred embodiment, the incident angle of the ion beam is preferably set in a range of 0 to 90° with respect to the surface of the polymer material.

In one aspect, the present invention preferably provides a plastic prepared by the method of any one of the aspects described herein, the plastic preferably including a nano-embossing pattern having a width of 1 to 1,000 nanometers and a length of 1 to 10,000 nanometers suitably formed on the surface of the polymer material.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum).

As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A is a schematic diagram showing an ion beam treatment performed on the surface of a flat surface of polypropylene in accordance with an exemplary embodiment of the present invention;

FIG. 1B is a scanning electron microscope (SEM) image of the surface of polypropylene on which an embossing pattern in accordance with an exemplary embodiment of the present invention is formed;

FIG. 2A is an SEM image of the surface of polypropylene before a surface treatment;

FIG. 2B is an SEM image of the surface of polypropylene treated at a voltage of 1,000 eV using an argon ion beam for 5 minutes in a preferred Example of the present invention;

FIG. 2C is an SEM image of the surface of polypropylene treated at a voltage of 1,000 eV using an argon ion beam for 30 minutes in another preferred Example of the present invention;

FIG. 2D is an SEM image of the surface of polypropylene treated at a voltage of 1,000 eV using an argon ion beam for 50 minutes in a preferred Example of the present invention;

FIG. 3 is a graph showing the results of Raman spectrum analysis in the Example of the present invention, in which a change in the chemical bonding of the surface of polypropylene according to the argon ion beam treatment is shown;

FIG. 4 is a graph showing the test results in another preferred Example of the present invention, in which a change in the roughness of the surface of polypropylene according to the argon ion beam treatment time is shown; and

FIG. 5 is a graph showing the test results in a preferred Example of the present invention, in which a change in the coefficient of friction of the surface of polypropylene according to the argon ion beam treatment time is shown.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a method for preparing a plastic with a nano-embossing pattern formed on the surface thereof, the method comprising performing a surface treatment on the surface of a polymer material in a vacuum chamber by irradiating an ion beam onto the surface of the polymer material, thus forming a nano-embossing pattern on the surface of the polymer material.

In one embodiment, the irradiation time is controlled.

In another embodiment, the magnitude of an acceleration voltage is controlled.

In another further embodiment, the irradiation time of the ion beam is in a range of a few seconds to a few hours.

In still another embodiment, the magnitude of the acceleration voltage is in a range of 100 V to 100 kV.

In one embodiment, the ion beam is produced by plasma ionization of a gas, wherein the gas is selected from argon, oxygen, nitrogen, helium, and carbon tetrafluoride (CF₄).

In another embodiment, the pressure of the chamber is in a range of 1.0×10⁻⁷ to 2.75×10⁻³ Pa.

In another further embodiment, the incident angle of the ion beam is set in a range of 0 to 90° with respect to the surface of the polymer material.

The invention also features a plastic prepared by the method of any one of the aspects described herein.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In certain preferred aspects, the present invention provides a plastic with a nano-embossing pattern that is suitably formed on the surface of polypropylene (PP) and other various polymers, the embossing pattern preferably having a width and height of several tens of nanometers (nm).

According to preferred embodiments, the present invention is directed to simply forming a nano-embossing pattern, which may be difficult to form by existing complicated hot-embossing methods, and as a result of analyzing the wetting angle of the plastic surface, the change in the surface composition, and the sliding characteristics by a scratch test, the present invention preferably provides a nano-embossing pattern having novel properties.

In further preferred embodiments, the present invention is directed to suitably forming a nano-embossing pattern using a dry etching process and suitably forming a hierarchical structure by binding with a microscale embossing pattern.

The features of the present invention can preferably be understood through a method of treating the surface of polypropylene (PP) having a nanostructure, the evaluation of the chemical structure of the thus formed nano-embossing pattern, and the evaluation of the wettability behavior on the thus formed nano-embossing pattern.

Certain preferred exemplary embodiments of the present invention are described in more detail with reference to the accompanying drawings.

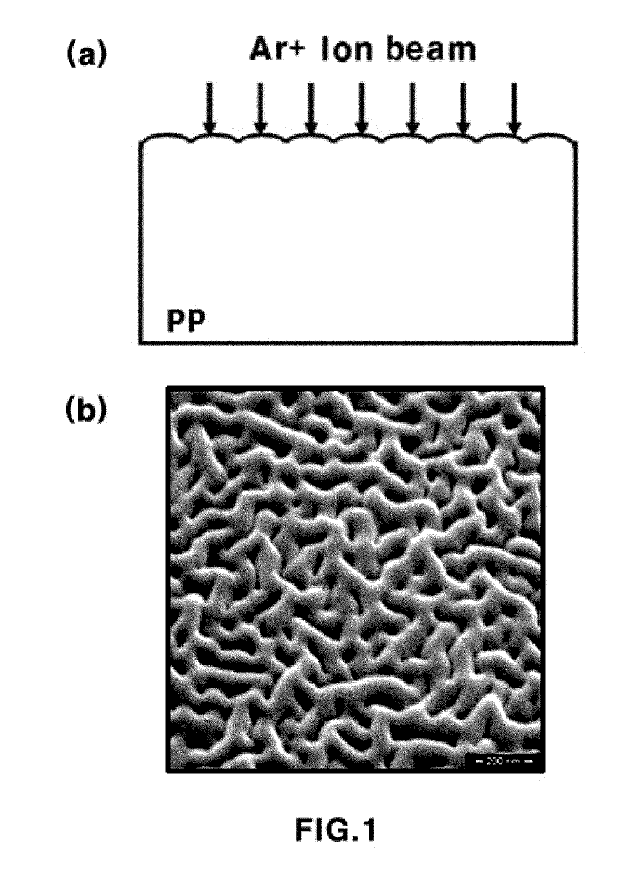

According to certain preferred embodiments and as shown in FIG. 1A, FIG. 1A is a schematic diagram showing an ion beam treatment suitably performed on the surface of a flat surface of polypropylene (PP) in accordance with an exemplary embodiment of the present invention, and FIG. 1B is a scanning electron microscope (SEM) image of the surface of PP on which an embossing pattern in accordance with an exemplary embodiment of the present invention is suitably formed.

According to certain preferred embodiments of the present invention, an ion beam is preferably irradiated onto the surface of a polymer material, for example, especially polypropylene (PP), using a broad ion beam under high vacuum conditions, thus suitably forming a nano-embossing pattern on the surface of polypropylene.

In certain exemplary embodiments, the ion beam may preferably comprise a gas selected from the group consisting of, but not limited to, argon, oxygen, and carbon tetrafluoride (CF₄) formed by plasma ionization. In other preferred embodiments, the nano-embossing pattern may be suitably formed on the polymer surface using, for example, an ion beam method, a method of forming a thin film, or a method of sputtering metal and non-metal materials.

According to further preferred embodiments, the shape of the nano-embossing pattern can be suitably controlled by controlling at least one of the irradiation time of the ion beam and the magnitude of the acceleration voltage.

According to certain exemplary embodiments, the conditions for forming the nano-embossing pattern are as follows. The pressure in a treatment chamber in which the ion beam treatment is performed is preferably in a range of 1.0×10⁻⁷ to 2.75×10⁻³ Pa, the magnitude of the acceleration voltage of the focused ion beam during the ion beam treatment is preferably in a range of 100 V to 100 kV, and the incident angle of the ion beam during the ion beam treatment is preferably in a range of 0 to 90° with respect to the polymer surface, and in certain further embodiments is preferably 90°.

In further exemplary embodiments, besides the polypropylene (PP), the polymer material, on which the nano-embossing pattern is suitably formed by the above-described ion beam treatment may comprise one selected from the group consisting of, but not limited only to, polycarbonate (PC), polyimide (PI), polyethylene (PE), polymethylmethacrylate (PMMA), polystyrene (PS), poly(lactic-co-glycolic acid) (PLGA), hydrogel, polyethylene terephthalate (PET), silicone rubber, and polydimethylsiloxane (PDMS), which can have a nanoscale roughness on the surface thereof.

The present invention will be described in more detail with reference to the following Examples; however, the present invention is not limited by the same.

### EXAMPLE

In one exemplary embodiment, a translucent polypropylene (PP available from LG Chemical Ltd.) sample was placed in a vacuum chamber at a vacuum of less than 0.01 mTorr, in which the voltage between the cathode and anode of an ion gun in the vacuum chamber was 1,000 V and the ion beam of the ion gun was preferably oriented vertically with respect to the surface of the PP sample.

Under these conditions, the ion beam irradiation time of the ion gun was changed from five minutes to two hours.

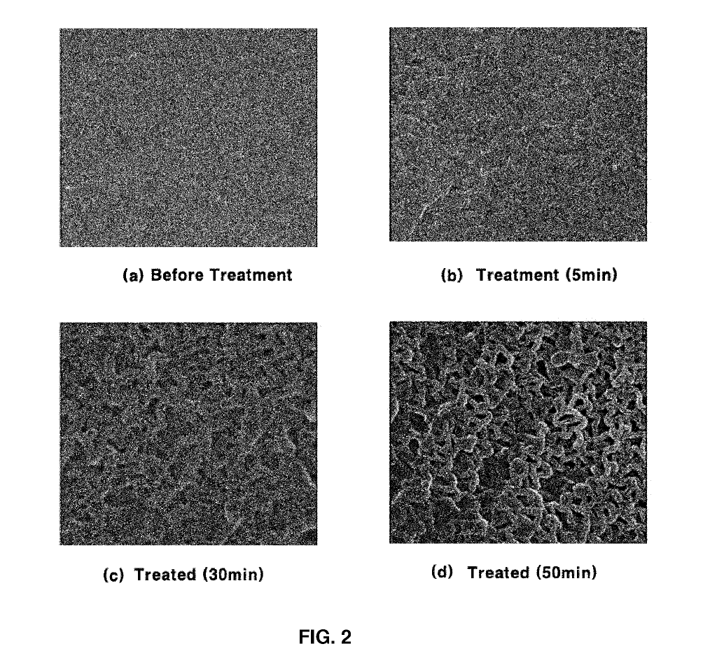

Accordingly, argon (Ar⁺) ion beam treatment was performed on the surface of the PP sample having a flat surface while changing the argon ion beam treatment time from five minutes to two hours (e.g., 5, 30, and 50 minutes), and the results are shown in FIGS. 2A to 2D.

FIGS. 2A to 2D are SEM images of the surfaces of polypropylene before and after the ion beam treatment, from which it can be seen that the surface of polypropylene was suitably embossed in a nanostructure with an increase in the amount of ions according to an increase in the ion beam irradiation time (5, 30, and 50 minutes), and thus the roughness was gradually increased.

According to exemplary embodiments of the present invention, a reason that the nano-embossing pattern is formed on the surface of polypropylene after the ion beam treatment can be as follows. Preferably, when the surface of a polymer such as polypropylene is suitably treated with an ion beam or plasma, the polymer chains of the soft polymer surface are rearranged, the C—H bond on each polymer chain is broken, and the amount of C—C bonds is increased, which results in a hardening of the polymer surface.

At the same time, deformation occurs on the hardened surface, and thus the nano-embossing pattern is suitably formed to mitigate the deformation.

As shown in FIGS. 2A to 2D, the width and height of the nano-embossing pattern had a close relation to the amount of ion beam energy during the ion beam treatment and, especially when the amount of ion beam energy, i.e., the amount of ion beam treatment time, was suitably increased, the width of the wrinkle of the nano-embossing pattern formed on the surface of the polymer material such as polypropylene was continuously increased, thus forming a serpentine micro-column arrangement.

### Test Example 1

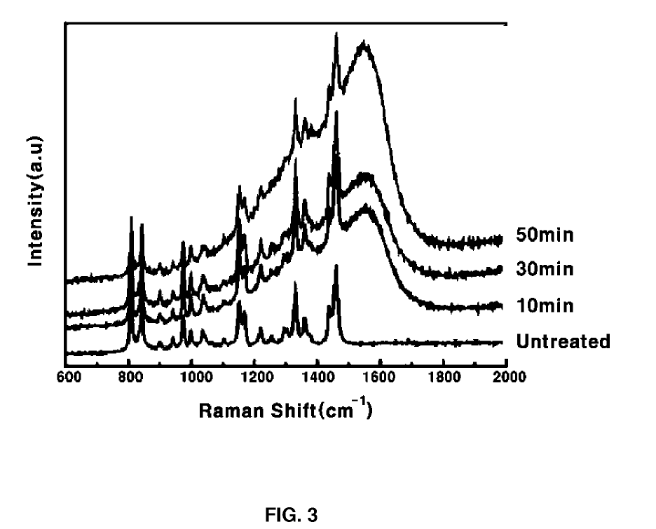

FIG. 3 is a graph showing the results of Raman spectrum analysis, in which a change in the chemical bonding of the surface of polypropylene before and after the ion beam treatment is shown.

According to further exemplary embodiments and as shown in FIG. 3, while the surface of PP before the ion beam treatment exhibits typical properties of amorphous polymer, the surfaces of PP after the ion beam treatment exhibit the peaks, which are typically shown in an amorphous carbon thin film.

Accordingly, the surfaces of PP after the ion beam treatment exhibit D (disordered graphitic) peaks at about 1,365 cm⁻¹ and G (crystalline graphitic) peaks at about 1,540 cm⁻¹, which are typically present in an amorphous carbon thin film.

Therefore, it can be seen that the soft polymer surface was suitably changed into an amorphous carbon layer having considerable hardness by the ion beam treatment, and it can be inferred that the electrical conductivity of the polymer surface was simultaneously changed by the ion beam treatment.

### Test Example 2

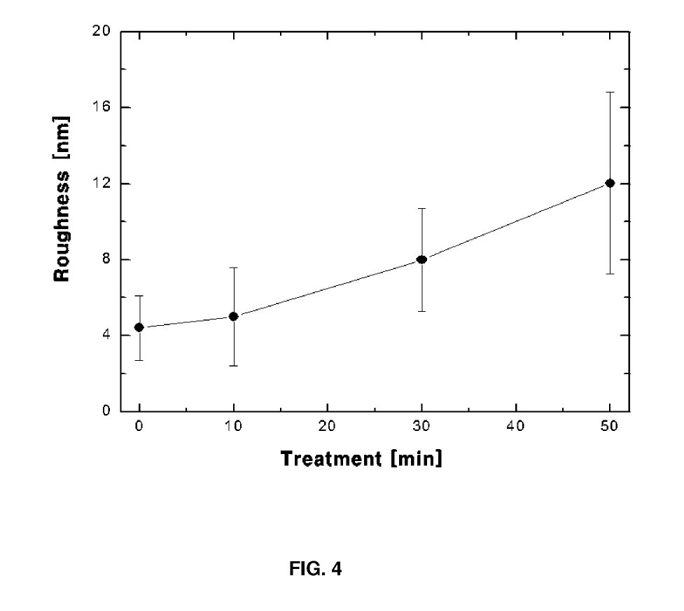

FIG. 4 is a graph showing a change in the roughness of the surface of polypropylene in accordance with a preferred Example of the present invention measured using an atomic force microscope (AFM).

In FIG. 4, the error bar represents the standard deviation.

It can be seen from FIG. 4 that the nano-embossing pattern having a considerable depth was suitably formed on the surface of the PP sample according to an increase in the surface treatment time, i.e., the argon ion beam irradiation time, thus suitably increasing the surface roughness, which exhibits the same tendency as the SEM images of FIGS. 2B to 2D.

### Test Example 3

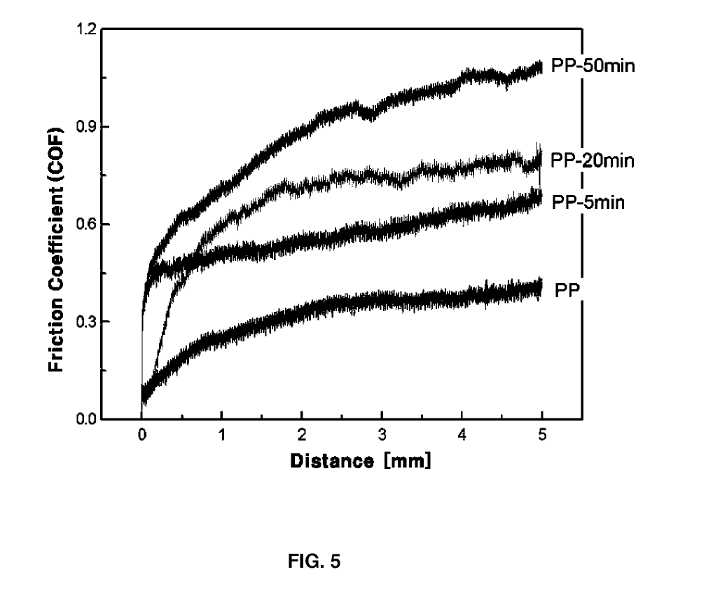

In another exemplary embodiment and as shown in FIG. 5, FIG. 5 is a graph showing a change in the coefficient of friction (COF) of the nano-embossing pattern formed on the surface of polypropylene in accordance with a preferred Example of the present invention by the ion beam surface treatment.

The change in the coefficient of friction was measured in such a manner that a vertical force of 200 mN was suitably applied to the surface of polypropylene using a scratch tester (J&L, Korea Rep.) and the total sliding distance was fixed at 5 mm.

As a result, and as it can be seen from FIG. 5 that the coefficient of friction was suitably increased by an increase in the sliding distance at an early stage and then had a constant value.

Further, it can be understood that the coefficient of friction of the surface was suitably increased by the increase in the ion beam treatment time on the polypropylene surface, i.e., by the increase in the roughness of the polypropylene surface.

Accordingly, it can be seen from the results of the Test Examples that the roughness is suitably increased by the nano-embossing pattern formed on the surface of the polymer material such as polypropylene, the increased roughness has non-slip (anti-slip) properties, and the non-slip properties are suitably appropriate for the surface pattern for interior and exterior materials required in the micro or nano-scale embossing pattern. As a result, the plastic with the nano-embossing pattern in accordance with the present invention can suitably satisfy the design requirements that finely adjust the size of the embossing pattern and the functional requirements that improve the prevention of stain due to static electricity, the scratch resistance, and the anti-sliding performance and produce high quality with an improvement in color, thus being usefully applied in various fields such as interior and exterior materials for vehicles, home electronic appliances, electronic devices, etc.

According to preferred embodiments of the present invention as described herein, the nano-embossing pattern is suitably formed on the surface of various polymer materials such as polypropylene (PP) by a simple method of irradiating an ion beam on the surface thereof, and thus the plastic with the nano-embossing pattern formed on the surface thereof can be usefully applied in various fields such as, but not only limited to, interior and exterior materials for vehicles, home electronic appliances, electronic devices, etc.

Further, the plastic with the nano-embossing pattern formed on the surface thereof in accordance with the present invention can suitably satisfy the design requirements that finely adjust the size of the embossing pattern and the functional requirements that suitably improve the prevention of stain due to static electricity, the scratch resistance, and the anti-sliding performance and produce high quality with an improvement in color, thus being usefully applied in various fields such as, but not limited only to, interior and exterior materials for vehicles, home electronic appliances, electronic devices, etc.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for preparing a plastic with a nano-embossing pattern formed on the surface thereof, the method characterized in that: a surface treatment is performed on the surface of a polymer material in a vacuum chamber by irradiating an ion beam onto the surface of the polymer material while controlling the irradiation time and the magnitude of the acceleration voltage, thus forming a nano-embossing pattern on the surface of the polymer material.

2. The method of claim 1, wherein the ion beam is produced by plasma ionization of a gas, wherein the gas is selected from the group consisting of: argon, oxygen, nitrogen, helium, and carbon tetrafluoride (CF₄).

3. The method of claim 1, wherein the pressure of the chamber is in a range of 1.0×10⁻⁷ to 2.75×10⁻³ Pa.

4. The method of claim 1, wherein the shape of the nano-embossing pattern is controlled by controlling at least one of the irradiation time of the ion beam and the magnitude of the acceleration voltage.

5. The method of claim 4, wherein the irradiation time of the ion beam is in a range of a few seconds to a few hours and the magnitude of the acceleration voltage is in a range of 100 V to 100 kV.

6. The method of claim 1, wherein the incident angle of the ion beam is set in a range of 0 to 90° with respect to the surface of the polymer material.

7. A plastic prepared by the method of claim 1, the plastic comprising a nano-embossing pattern having a width of 1 to 1,000 nanometers and a length of 1 to 10,000 nanometers formed on the surface of the polymer material.
